(19) United States
(12) Patent Application Publication
(10) Pub. No.: US 2009/0161212 A1
(43) Pub. Date: Jun. 25, 2009

(54) Weld viewing

(76) Inventor: Yuma E. Gough, Wyoming (CA)

Correspondence Address: CHRISTOPHER JOHN RUDY, 209 HURON AVENUE, SUITE 8, PORT HURON, MI, 48060, US

(21) Appl. No.: 12/316,604

(22) Filed: Dec. 15, 2008

Related U.S. Application Data
(60) Provisional application No. 61/009,058, filed on Dec. 21, 2007.

(51) Int. Cl. G02B 27/22; G02B 5/08

(52) U.S. Cl. 359/462; 359/850

(57) ABSTRACT

A mirror may have hole(s) in or passing through its viewing surface. A video remote may be associated with the mirror, especially as configured with the hole(s). A gas, typically an inert gas, may be passed about or through the mirror system, for example, through one or more of the hole(s) through the viewing surface. The mirror may be part of a mirror system, which can be combined with a welding torch. Obscured sites may be inspected and/or welded therewith.

This claims the benefits under 35 USC 119(e) of provisional patent application No. 61/009,058 filed on Dec. 21, 2007 A.D. The complete specification of that application, to include its drawings, is incorporated herein by reference.

### FIELD AND PURVIEW OF THE INVENTION

This concerns a visual aid for welding, for example, a mirror with or without a hole in it and with or without an accompanying video remote, and use of the visual aid in welding or inspecting. The mirror can be fixed about a welding torch. Gas tungsten arc welding (GTAW), also known as tungsten inert gas (TIG) welding, and TIG welding torches and/or plasma arc welding (PAW) and PAW torches can be of special concern.

### BACKGROUND TO THE INVENTION

A problem not infrequently facing a welder is that of an obscured weld site, i.e., an area where a weld is to be made in which some or even none of the area can be seen from the welder's position. Several known devices and methods attempt to address this.

For example, a mirror may be fixed in a stationary position across from the area to be welded so that the welder can view the reflection of the weld region in the mirror. The mirror is used to visually observe a reflected weld puddle to help in making the weld. A drawback to this is that it requires the mirror to be placed far enough back from the site of the weld to allow room for the welding torch and filler wire to be passed and operated without hindrance. The farther back the mirror is placed, the smaller the image in the mirror appears, which increases difficulty in the job and usually results in repositioning the mirror often. This can be overcome with a larger mirror, but only if there is adequate spacing for it. Another problem with a stationary mirror is that the welding torch angle is always changing in the reflection of the mirror as the welding proceeds. This makes the operation hard to learn. Also, when the mirror is behind the welding torch, the welding torch itself can obscure the reflection of the weld puddle as the welding process advances along the weld joint. This requires a high level of welding skill, and the length of welds that can be achieved before having to stop welding to reposition the mirror is reduced.

Also, another person may hold a mirror for the welder and advance the mirror along with the welder as welding progresses. This requires not only that both workers be proficient in their skills but also that there be timely coordination in their efforts.

Then, too, one person, generally a welder, can view the obscured weld site, and a second person, a welding operator, make the weld. In this arrangement, the first welder views the welding operation, either directly or with a mirror for his own viewing. This first welder verbally directs the second welder, who controls the welding torch, throughout the welding operation. In some cases, there can be more than two welders involved, who serve as viewer(s) or operator(s) or both. Such an arrangement requires not only proficiency in welding skills but also timely coordination in effort coupled with a very high degree of verbal acuity and aural understanding.

Generally, such methods are time-consuming, and may put great if not impossible demands on welders. The possibility of weld repairs is increased, and productivity and operator comfort are reduced when working under such difficult situations. The number of man-hours involved in team-welding situations can engender high expense.

In addition, a camera or fiber optic light conductor may be employed to transmit an image of the weld region to a monitor for display. This can be effective in certain situations in spite of the increased cost and complexity of operation. Such equipment, however, can be damaged from the intensity of heat and the metal spattering that occur about the weld site, and repeated replacement of the equipment can accelerate costs.

Also, welding in constricted areas where an obstructed weld site may be encountered may be carried out by automatic welding systems. These are systems that are fixed to the object to be welded and programmed to perform the welding operation through use of remote control or a program. Automatic welding systems require much more sophisticated equipment, more elaborate setups, and even more extensive operator training than simpler expedients such as a simple mirror and team-welding. The higher costs associated with automatic welding systems are only an option when costs can be offset with higher production numbers. In some situations, such known systems are too cumbersome to use, leaving the job to be done manually in its entirety. Also, there is often a need to use manual welding techniques for areas that such a system can not access, or for any unfortunate weld repairs that need to be made since weld repairs are usually better performed with manual welding than with an automatic welding system. Nonetheless, automatic welding systems have their place.

It would be desirable to ameliorate if not overcome one if not more of such problems and drawbacks and to improve efficiency and reliability in welds made in obstructed weld sites. It would be desirable to extend the reach of automatic welding systems. It would be desirable to provide alternative(s) to the art.

### A FULL DISCLOSURE OF THE INVENTION

In general, provided is, in combination, a welding torch and a mirror system attached to the torch. Accordingly, a mirror can be attachable to a welding torch. The mirror may be attachable to the torch by a member attached to the mirror such that the mirror can be adjustable. The mirror of the mirror system, which is a unit that includes the mirror, can be a front surface mirror. The mirror may have an imperforate viewing surface, which is to say that it may have hole(s) in or passing through its viewing surface. A video remote may be associated with the mirror, especially as configured with the hole(s). The mirror with or without the video remote, which generally includes an optical image pick up device, may be provided attached in combination with the welding torch. A gas, typically an inert gas, may be passed about or through the mirror system, for example, through one or more of the hole(s) through the viewing surface. Even further element(s) and/or part(s) may be provided. The welding torch may include adaptation(s) for receiving the mirror system, the video remote and/or passing the gas about the mirror system. Such may be employed in welding methodology. Accordingly, this aspect of the invention is useful, in general, for welding torches and welding at an obscured weld site.

As well, provided is an article of manufacture comprising a mirror with a reflective surface, which has at least one hole through the reflective surface; and an optical image pick up device, which can receive light that passes through said hole(s). Accordingly, this aspect is also useful, in general, for observation in a harsh environment, say, in a furnace, underwater, and so forth, with or without torch welding, and in welding.

Significantly, by the invention, the art is advanced in kind. One if not more problems and drawbacks in the art is ameliorated if not overcome, and efficiency and reliability in welds made in obstructed weld sites is notably improved. The adjustable member can be provided simply and efficiently by a flexible member, and it can provide for a mirror of minimal size attached to the head or other portion of a welding torch, and efficiently aid a welder's view of an obscured weld region. It is adaptable to a variety of welding torches, and allows the welder to effectively view the welding operation that is otherwise out of sight when welding in difficult situations. With the mirror attached to the welding torch, the relative angle of the mirror to the welding torch is maintained. This makes viewing the welding operation much easier as the mirror always moves with the welding torch, as opposed to situations in which a mirror is placed in a stationary location adjacent to weld region to be viewed. Furthermore, an economical, compact and transportable solution to remotely viewing a weld region is provided. The mirror, especially with the hole(s) in its viewing surface, can serve as a shield behind which a camera, fiberscope lens, or any image pick-up device can be placed or fitted. Such a mirror can serve not only to shield the sensitive equipment from the intense arc, rays, and heat of the welding operation, but also to reflect arc light back to the weld region. This further illuminates the weld region and increases the amount of light gain for the image pick-up device, and illuminates areas where shadows would otherwise be created from the intense arc light at a low angle of attack to the welding surface. The invention can be compact, rugged, simple, effective, and very economical. It can extend the reach of automatic welding systems. Thus, if an automatic type welding system is used, viewing of the weld region can be facilitated by having the mirror, say, with associated remote viewing equipment, attached to the welding torch or welding head of the automatic or semi-automatic welding machine for direct viewing by the operator. Also, inspections in harsh environments are improved. The instant invention provides alternative(s) to the art.

Numerous further advantages attend the invention.

The drawings form part of the specification hereof. With respect to the drawings, which are not necessarily drawn to scale, the following is briefly noted:

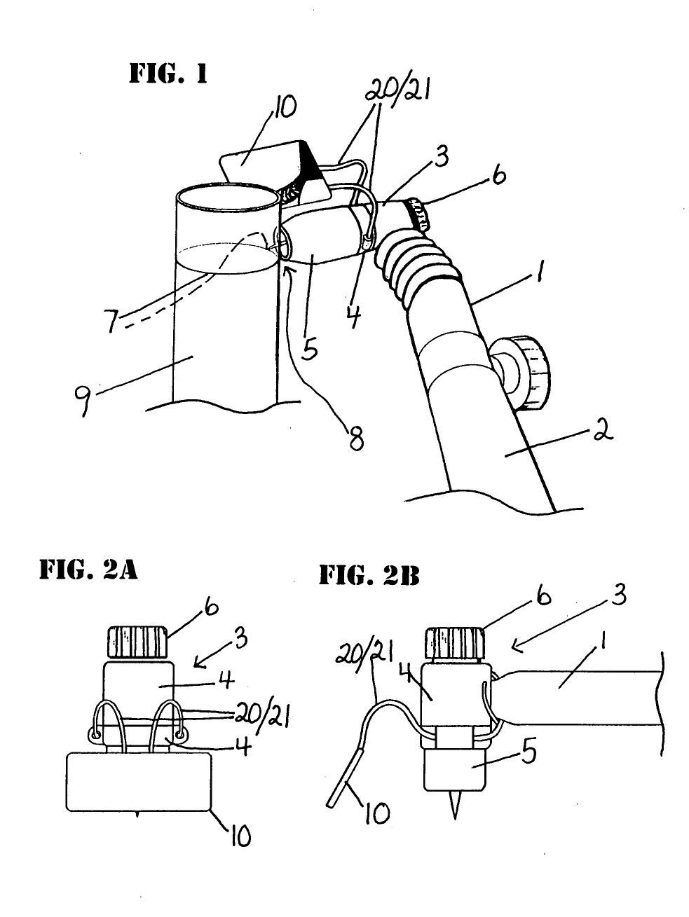

FIGS. 1-34B show embodiments of a mirror attachable to a welding torch, some with an adjustable support member attached to the mirror, and some in combination with a welding torch.

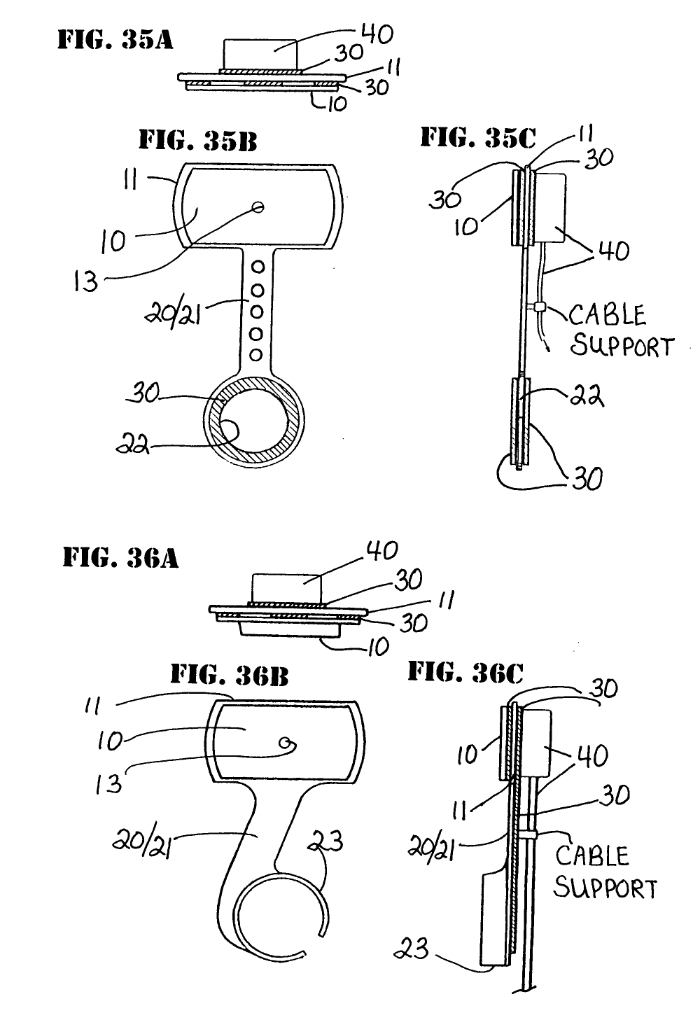

FIGS. 35A-54 show further embodiments of a mirror attachable to a welding torch; some have an adjustable support member attached to the mirror; some have a device or a means for receiving, transmitting to and displaying the image of a weld region at a viewing display, say, at a location remote from the weld region; and some are in combination with a welding torch.

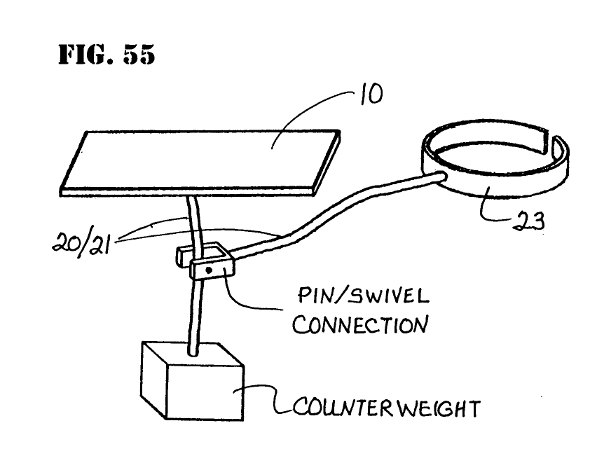

FIG. 55 et seq. show additional embodiments.

The invention can be further understood by the detail set forth below, which may be read in view of the drawings. As with the foregoing, the same is to be taken in an illustrative and not necessarily limiting sense.

In combination with the welding torch can be a mirror system, which, by nature includes the mirror. Element(s) additional to the mirror and torch can be provided. Such a combination can be provided as a one-piece integral unit of torch and attached mirror system, or provided as a multi-piece assembly, for example, of a mirror system attachable and then attached to the torch, which further may be reversible and/or taken apart.

The mirror is attachable to a welding torch, and it can be made of any suitable material. The mirror, however, and its adjustable member and any additional elements for attaching it to the target welder, can encounter and must endure a harsh environment since welding, and arc welding in particular, can produce a great amount of heat, visible light, ultraviolet (UV) light, sparks and/or spatter. Also, a risk of electrical short circuiting to conductive parts of the invention from the welding arc may be posed. These conditions are addressed with the use of heat resistant and insulative materials.

A tempered glass or quartz mirror may be used, but an associated ghost image, a reflection from the front side of the glass or quartz associated with reflection of the mirrored back side of the mirror, can occur, which confusing double image is exaggerated with extra light from the welding arc, and such materials are fragile and susceptible to damage. Accordingly, a front surface mirror, for example, a polished metal mirror, most notably of stainless steel, can be employed. Stainless steel is a very durable material resistant to harsh temperatures, corrosion, impacts, and, scratching. Also, stainless steel as with other polished metal mirrors, will give a true reflection without giving a ghost image. A plated metal mirror can be employed. Other material(s) may be employed. For instance, the mirror may be made of ceramic and have a surface so highly polished that is serves as an effective reflective surface, say, as a front surface mirror. Accordingly, the mirror is able to withstand the harsh environments that are encountered in the welding industry.

The mirror can have a suitably small size, say, with a reflective surface or primary outer boundary independently at each occurrence approximately one-half, one, one and one half, or two inch(es) by one-half, one, one and one half, two, or two and one half inch(es). It may assume any suitable shape, for example, having a slim profile with the primary outer boundary a rectangle, square, triangle, truncated oval, truncated ellipse, truncated circle, oval, ellipse circle and so forth; and its reflective surface may be entirely planar, convex or concave, or have portions that are planar, convex and/or concave.

More than one mirror may be employed. For example, when a single mirror provides for an insufficient field of view such as when there is restricted access and the mirror is not visible or the viewing angle of attack relative to the welding position is too great, two, three or more mirrors may be employed. Also, a second mirror can be employed to view the reflection in a first mirror, say, when the first mirror is out of sight to the welder, or when a non-reversed image of the weld region is desired.

The mirror is not necessarily restricted to use in situations with obscured weld regions. It may be desirable to utilize the durable mirror for other tasks.

A proper viewing angle is readily achieved with an attaching member that is adjustable, which can connect the mirror with the torch and support the mirror in a stable, fixed position during welding. This allows the user to view the weld region at the head of welding torch from many positions if not any desired position. The adjustable attaching member can be a flexible wire, for example, made of copper, which can be easily bent to a desired position and remain there during welding. The adjustable attaching member, nonetheless, may be a ball socket type swivel joint, a swiveling cylinder in a yoke, or any of a number of other expedients. As to its size, it may be of any suitable length, width and thickness, say, independently at each occurrence approximately from one half, one, two or three to four, six, nine or twelve inches in length with a narrow width and/or thickness determined for the most part by stability requirements.

Attachment to the torch may be carried out with a suitable adjustable attaching member itself, say, the portion of a flexible wire distant from the mirror. Also, a clamp, spring clip or other suitable device may be employed to attach the mirror or mirror and the adjustable or a non-adjustable attaching member to the welding torch. Accordingly, the mirror system, say, the mirror or the mirror and adjustable or non-adjustable attaching member, may be attached to any type of welding torch or any other device for similar use. Thus, for example, manual, automatic or semi-automatic welding devices or systems may be equipped with the mirror or mirror and flexible member.

Flexible and/or telescopic handles may be attached to the mirror, adjustable member and/or another element, say, for adjustments, general inspections, or inspection of hot objects. A suitable high-temperature magnet may be incorporated for fixing to a magnetic surface for hands-free use. A magnet may also attach a mirror system to the torch, as may hook and loop materials, wire wraps, clips, and/or washers and so forth.

Insulation can be used to shield items from the harsh conditions of the welding environment and to prevent electrical short circuiting to electrically conductive components of the invention. The reflective properties of the mirror can be utilized to reduce the absorption of heat gained by reflecting the arc rays of the welding arc away. This is especially useful as a means of protecting any optical image pick-up device, when that feature is employed. Insulation placed between the mirror and the support structure to the mirror can reduce the amount of heat conduction as well. Sometimes attachment to an area of the welding torch occurs where there is less tolerance to high temperatures, and depending on the type of attachment, heat otherwise conducted to that area of the welding torch can be minimized by including insulation to minimize or arrest heat flux. Various attachments can be employed, for example, in affixation to a gas nozzle of the welding torch. Typically, the gas nozzle is made of very durable, heat-resistant material such as ceramic, porcelain, quartz or glass. The gas nozzle proves to be an excellent location of attachment. Many other attachments and sites for the same are possible.

Also, insulation can be formed and used to provide additional useful functions other than insulation. For example, in a case in which a flexible copper wire is used as an adjustable support for the mirror, coating the copper wire with a flexible, heat resistant material such as high heat silicone can give additional strength and reliability to the flexible support member as well as increase rigidity. Thus, heat gain and electrical short circuiting can be reduced. And so, an insulator may be employed to minimize or arrest electrical flux. Also, the adjustable member such as a flexible wire may have a built-in bend radius limiter to prevent kinking of the wire when bent, thus serving to extend the life of operation. The insulation also may help to absorb minor shock and vibrations during welding. An insulating material such as glass, quartz, crystal or any like material can be used in areas where flexibility is not of great concern such as on the backside of the mirror. Then, too, the backside of the mirror can serve as a great location for indicia such as an insignia, logo or any sort of marking, and a glass insulator can be made to be clear so that an insignia imprinted on the backside of the mirror will be displayed through the glass.

The mirror or mirror with adjustable member can be made to be temporarily or permanently fixed to a welding torch and can be made to fold, tuck or slide away when not in use. The mirror can also be made as a removable piece from the welding torch, wholly or in part, either as part of the torches design or as an apparatus that is equipped to be uncoupled at some point between the attachment point and the mirror.

Furthermore, an optical image pick-up device for transmission of an image of the welding operation to a remote location may be provided. The optical image pick-up device can be of any suitable type. For example, an electronic CCD camera or a fiber optic fiberscope may be employed. A fiberscope can handle higher temperatures and is not compromised by being around high current electric fields, which are produced by the electric arc welding process. Generally, a fiberscope does not need a power source for operation since the arc of the welding process provides plenty of light in the weld region for fiber optics to receive, transmit and display the image of the weld region onto the image viewer display. Before and after welding a welding arc is not present; therefore, the weld region may not have the necessary amount of ambient light for the fiberscope to receive, transmit, and display the image of the weld region to the welder. In such a case, although, in general, the fiberscope does not require a light source other than the welding arc, additional light can be provided with an auxiliary light source. The auxiliary light source can be directly aimed at the weld region from any location thereabout. If the auxiliary light source is compact enough, it can be fixed to the mirror and/or attaching member, or to the welding torch, and aimed at the area where the weld is to be made. The auxiliary light source can be transmitted to the weld region with fiber optics. Fiberscopes are known, for example, in which a light source is coupled to the image viewer end of a fiberscope, with light from a light source transmitted through dedicated fiber optic light conductors within the fiberscope cable to the image receiving end of the fiberscope cable where the auxiliary light exits and illuminates the viewing area; and such fiberscopes or modifications thereof can be employed herein. Power for the auxiliary light source can be from a battery as small as an “AA” flashlight battery. The image viewer can be fitted with a coupling for receiving the auxiliary light source, or the image viewer can be designed to include a battery storage compartment, a power on/off switch, and a light source such as a light bulb or high intensity LED. Electronic cameras, however, allow for the possibility of wireless transmission and video recording for documentation purposes; also, there are certain video functions that can be utilized to edit, alter or enhance the image displayed on the video display. Generally, an electronic image pick-up device requires a power source for receiving, transmitting and displaying the image. The mirror can be unmodified or can have a small hole in its viewing surface, say, about its center, from where the optical image pick-up device can receive the image. Accordingly, the optical image pick-up device may be utilized by the welder in addition to directly viewing the reflected image in the mirror. The mirror or mirror with adjustable member can be utilized additionally when coupled with an optical image pick-up device: 1) to guide and support the optical image pick-up device and its transmission cable; 2) to shield the image pick-up device and its transmission cable from the harsh conditions of the weld regions intensely harsh environment; and/or 3) to serve as an illuminator, with the mirror reflecting arc light back to the weld region, to increase the amount of light gain for the optical image pick-up device and to reduce or illuminate any shadows created from the intense arc light being created at a relatively low angle of attack relative to the surface being welded.

The optical image pick-up device can be further protected from the surrounding temperatures with a protective shroud of insulation within a containing body. This body containing the insulated optical image pick-up device can then be further protected with a shroud surrounding the optical image pick-up device with a cooling, shielding gas. The shielding gas can be obtained from the same source of shielding gas that is used for the welding process. The shielding gas normally exits the gas nozzle onto and around the weld puddle to protect the molten metal from elements in the atmosphere. Only a small amount of shielding gas is required to keep the invention cool and there are a variety of ways of obtaining shielding gas for direction to the invention for cooling purposes.

Returning to the mirror, various mirrors may be interchanged with other mirrors, for example, to provide for a different size or shape. This can include the interchange of one mirror for another, which would serve as a better light reflector of a welding arc, say, when greater luminosity is desired for the optical image pick-up. Such a mirror as a reflector can be shaped to resemble the reflector of a flashlight with varying features to its general shape such as multi-facetted surfaces on a curved mirror or a parabolic dish. Also, the mirror may be utilized as a focal point for an optical image pick-up device, where, with the mirror fixed to the welding torch head for employment about the weld region, any suitable camera or fiberscope is fixed to the body of the welding torch, and the lens of optical image pick-up device is focused on the mirror. The mirror is adjusted to reflect the image of the weld area to the lens of the optical image pick-up device. An advantage of this latter arrangement is that the lens and transmission cable can be placed farther away from the weld region, and thus remain safe and more shielded from harm.

The present embodiments can be incorporated into the design of any welding torch as part of its design, or as a device designed to be attached to any number of existing welding torch designs. Also, any part or component of a welding torch can be modified to accept a mirror or mirror with adjustable member hereof.

Thus, welding with the mirror and/or its accessories hereby can be carried out with an otherwise common or modified welding torch in situations that pose difficultly with respect to accessibility and viewing, yet require high quality welds. And so, an obscured weld area may be encountered in which high quality welds can be produced.

A weld area may be considered to refer to the same thing as a weld region or site.

The welding torch may be a nonconsumable electrode electric arc welding torch. Inert gas shielding may be employed. The torch may be a GTAW or PAW torch.

With respect to the drawings, the GTAW (a.k.a. TIG) and PAW welding processes and their respective torches are found within the disclosures for FIG. 1 et seq. However, any other suitable welding process and its respective torch may be employed.

FIG. 1 depicts a perspective view of an embodiment of a mirror attached to a GTAW torch. The drawing is shown in a perspective situation from a welder's point of view, and illustrates a situation where only a portion of a workepiece, for example, a tube or pipe, to be welded is viewable to the welder. Attaching the stainless steel mirror with its flexible wire support member made from two heavy copper wires, say, of 14-gauge (14-AWG) or so, to the welding torch allows the welder to monitor the entire welding process that is otherwise out of sight. The welder is able to view the reflection of the weld region on the mirror and perform the weld process with ease, and the support structure for the mirror consists of the two copper wires can be bent to move and stably retain the mirror in any desired position.

FIG. 2A, a top end view, and FIG. 2B, a side view, show the same embodiment shown in FIG. 1. The support structure of the mirror is secured to the welding torch with a modified insulator. An insulator is a common component of welding torches, which serves to insulate the welding torch head from the gas nozzle and to act as a seal between the two parts. In this embodiment, the insulator is modified with a protrusion on each side with holes through them for receiving each copper wire support. The wires are fed through the holes, more or less, for adjustment of the mirror's distance from the welding torch head. Any excess wire can be bent around the back side of the insulator. Simple protrusions, hooks, slots, and so forth and the like may be substituted for the holes. When the gas nozzle is loosened slightly, the insulator is able to freely swivel around its axis. This enables adjustment of the mirror around the axis of the gas nozzle.

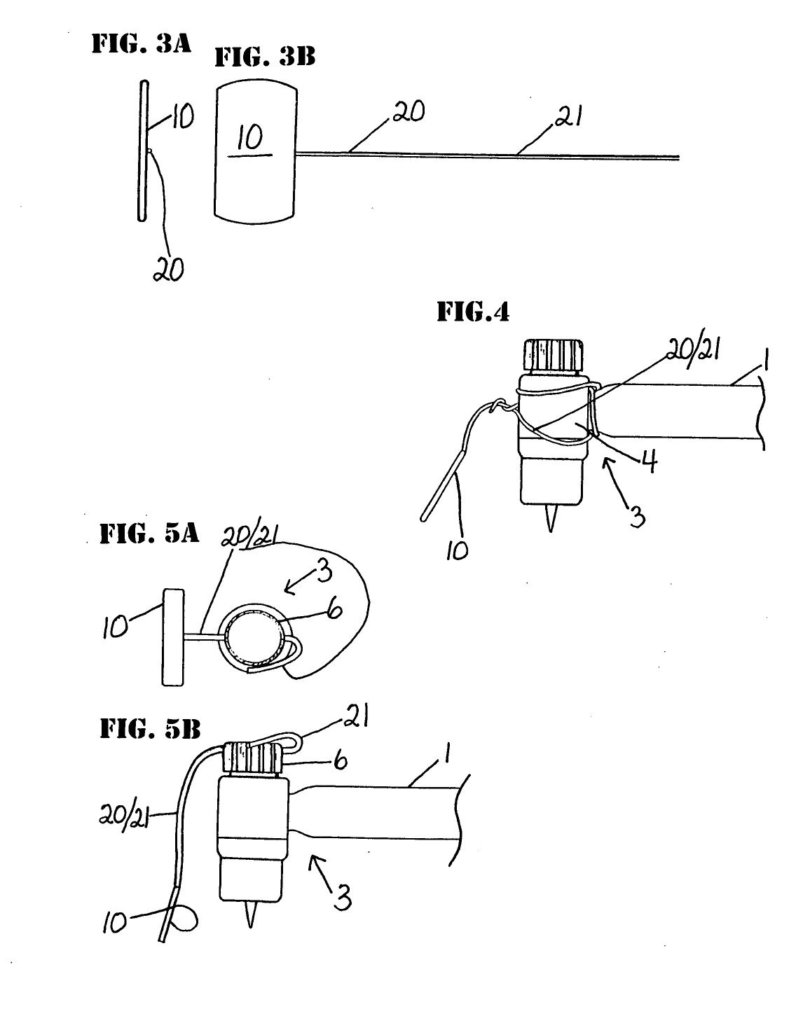

FIG. 3A, a side view, and FIG. 3B, a front view, show a mirror for attaching to a welding torch in one of its simplest forms. The mirror is fused to a single flexible wire. The wire can be simply wrapped in any configuration around the welding torch so as to maintain a steady and secure attachment to the torch.

FIG. 4 is a side view of the mirror of FIGS. 3A and 3B attached in combination with the head of a GTAW torch.

FIG. 5A, a top view, and FIG. 5B, a side view, show another embodiment of a mirror attachable to a welding torch. The welding torch cap is modified with a receiving hole. The hole receives the flexible support wire, and is bent around the welding torch cap to securely keep the mirror in place, steady and secure.

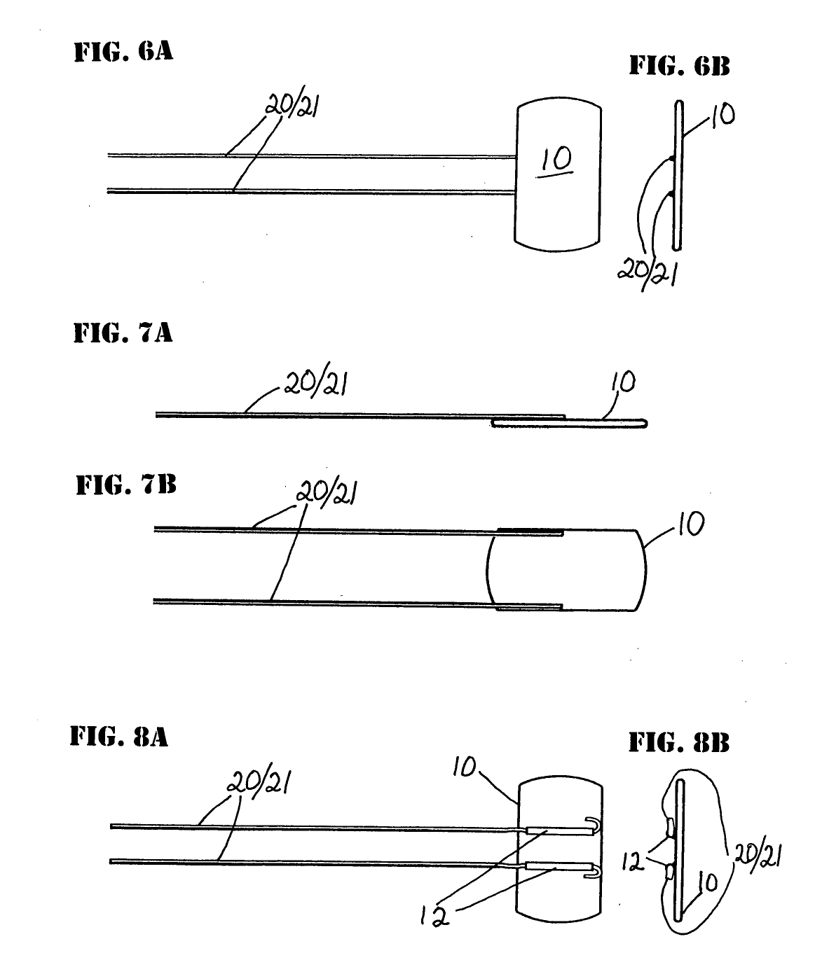

FIGS. 6A and 6B, and FIGS. 7A and 7B, show mirrors having flexible support wires fused thereto, with the FIG. 6A a front view, FIGS. 6B and 7A side views, and FIG. 7B a rear view. Compared to one wire, two or more support wires can increase stability for the mirror.

FIG. 8A, a rear view, and FIG. 8B, a side view, show a mirror equipped with hollow tubes. Each tube is capable of receiving and holding a flexible wire to hold the mirror in place and allow easy interchangeability of mirrors, say, for repair or replacement of a mirror of the same or a different size and configuration. The wires can be given slight bends on either side of the tube to keep the mirror secure in the desired position.

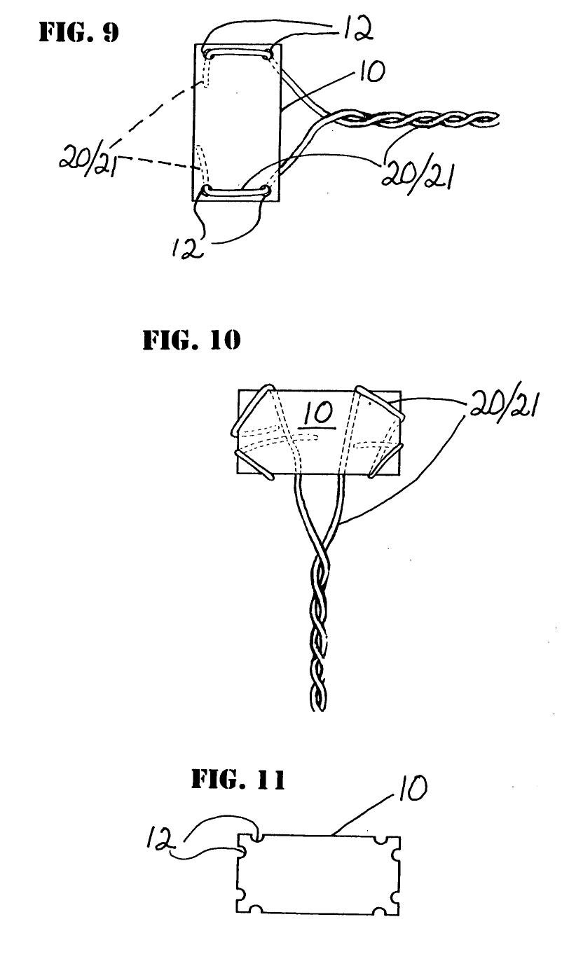

FIG. 9 is a front view of an embodiment in which a mirror is equipped with holes through which flexible support wires can be fed to provide attachability to a welding torch. The flexible support wires are twisted together to help contain and hold the wires.

FIG. 10 is a front view of an embodiment having a couple of flexible copper wires simply bent around a mirror to provide for welding torch attachability. Any suitable bending arrangement of the wires around the mirror may be employed.

FIG. 11 is a front view of a mirror with notches on its perimeter to allow flexible support wires to be easily attached to the mirror. Compare, FIG. 10.

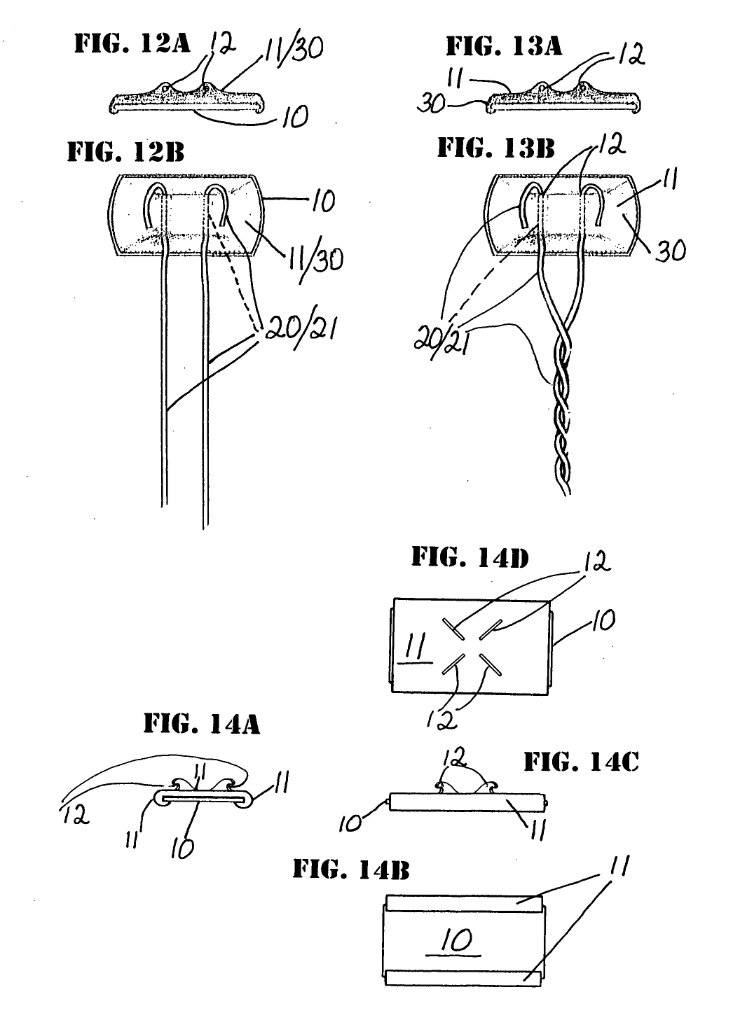

FIG. 12A, a top view, and FIG. 12B, a rear view, show a mirror that can be attached to a torch by a member, for example, an adjustable member, say, a flexible wire. The rear and peripheral edges of the mirror are encased with insulation material. The insulation material can protect the mirror, especially if it is made of an electrically conductive material such as stainless steel, from electric short circuiting; and can minimize transfer of heat from the mirror to other parts of the assembly. Glass, quartz, porcelain or ceramic are examples of materials that may serve as good insulators for this purpose, all of which, in general, are able to be manufactured easily. Any suitable manner of attachment of the insulation material to the mirror can be employed. The insulation can be formed to include receiving holes for receiving, for example, the adjustable member, say, the flexible support wires depicted in FIG. 12B, through which the wires can be fed through and bent slightly so as to retain their position and hold the mirror securely.

FIG. 13A, a top view, and FIG. 13B, a rear view, show the mirror in FIGS. 12A and 12B. The attaching member, however, is made of the two flexible support wires that are twisted together. The twisting helps to contain and control the wires, and further stabilize the mirror.

FIG. 14A, a top view, FIG. 14B, a front view, FIG. 14C, a side view, and FIG. 14D, a bottom view, show another mirror embodiment, which has a support to which the mirror can be attached. The mirror support provides for interchangeability of the mirror by letting the mirror slide in and out. Several posts protrude on the back side of the mirror support. Flexible support wires, or any other suitable form of attachment member, can be attached about such protrusions. A push button clamp can provide for adjustable, removable attachment. The mirror support can be made of an insulation type material.

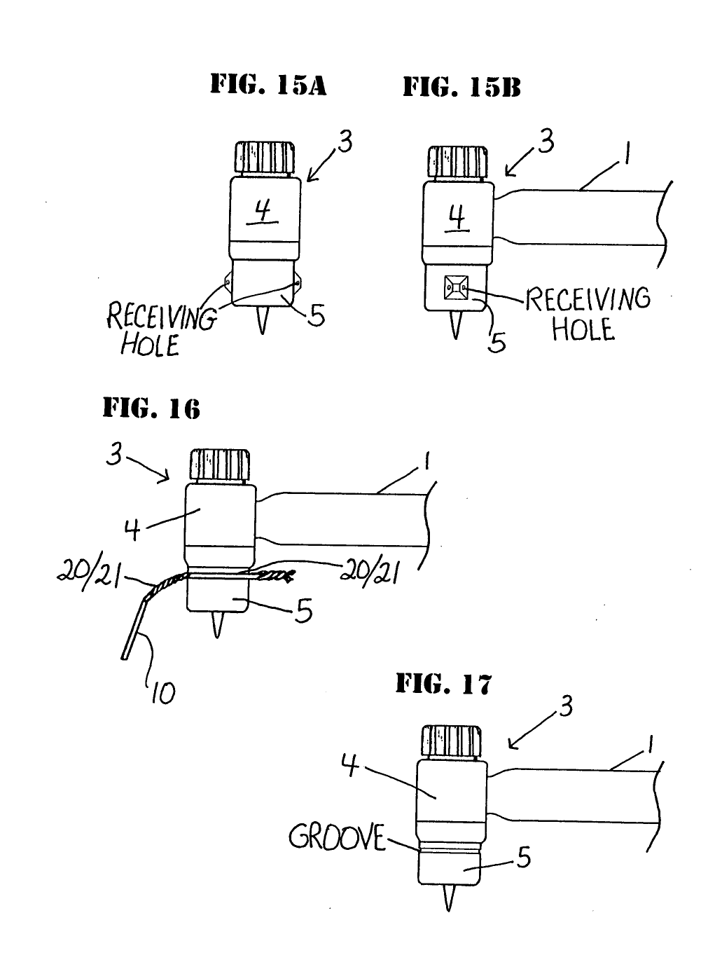

FIG. 15A, a top end view, and FIG. 15B, a side view, show an embodiment of a GTAW torch that is modified to receive the mirror by its attaching member, say, flexible wires, through receiving holes formed in the gas nozzle of the torch, which can receive the flexible support wires. Simple protrusions, hooks, slots, and so forth and the like may be substituted for the holes. Compare, FIG. 1.

FIG. 16 is a side view of an otherwise standard GTAW torch having a suitable attaching member for a mirror, for example, flexible support wires, simply wrapped around the upper portion of the gas nozzle of the torch with the insulator employed as a stable shoulder.

FIG. 17 is a side view of a GTAW torch having its gas nozzle modified with an annular groove. The annular groove in the gas nozzle provides for securing of a mirror to the torch by wrapping and/or tying a suitable attaching member, for example, flexible wire(s), around the groove. The groove gives a sturdy and stable anchoring point for the attaching member to sit securely on the gas nozzle. A plurality of grooves and/or attaching members may be provided and employed.

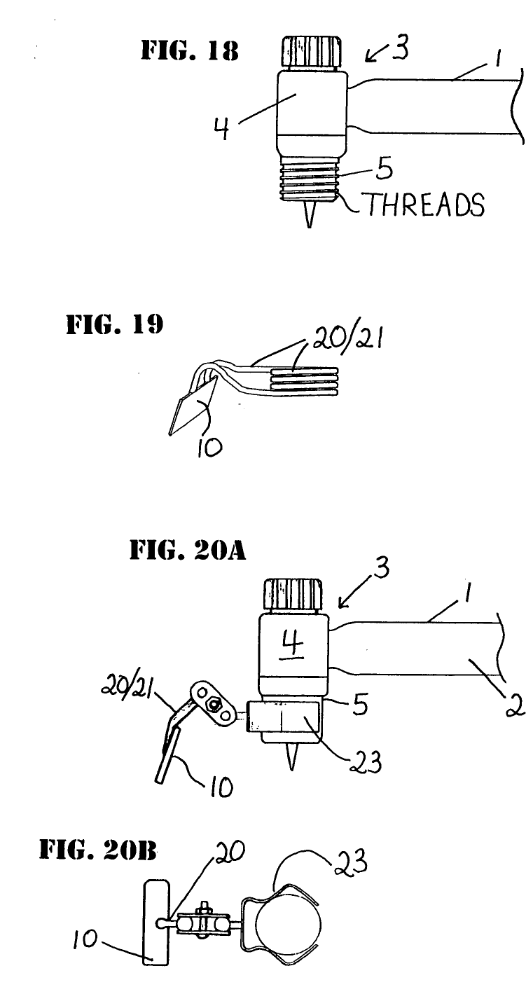

FIG. 18 is a side view of a GTAW torch having its gas nozzle modified with a spiraled screw like formation along its length. A mirror can be secured to the torch by screwing, wrapping and/or tying a suitable attaching member, for example, flexible wire(s), around the formation. Thus, the mirror and it attaching member can not only be attached to the torch but also detached readily such as by screwing and unscrewing. And so, the mirror and/or attaching member can be temporarily removed, swapped out for an alternate sized mirror, and so forth.

FIG. 19 is a side view of an embodiment of a mirror with an attaching member in which the attaching member is provided in a continuous unbroken path in a form a spiraled thread. Such an embodiment can be readily attached and detached to a torch with a gas nozzle as depicted in FIG. 18. It also can be of a size and made of a springy wire material to make use of its size and springiness to fit snugly over a standard gas nozzle that is not equipped with groves such that the tension between the two holds and supports the mirror in place.

FIG. 20A, a side view, and FIG. 20B, a top view, shows an embodiment of a mirror attached to an otherwise standard GTAW torch, in which the attaching member includes a double ball socket type swivel arm terminating with a metal spring clip. The spring clip allows for quick and easy mounting and dismounting of the arm and mirror to the torch. The spring clip can be incorporated in numerous ways, generally to suit any welding torch. A large variety of spring clips are commercially available for employment in such an embodiment.

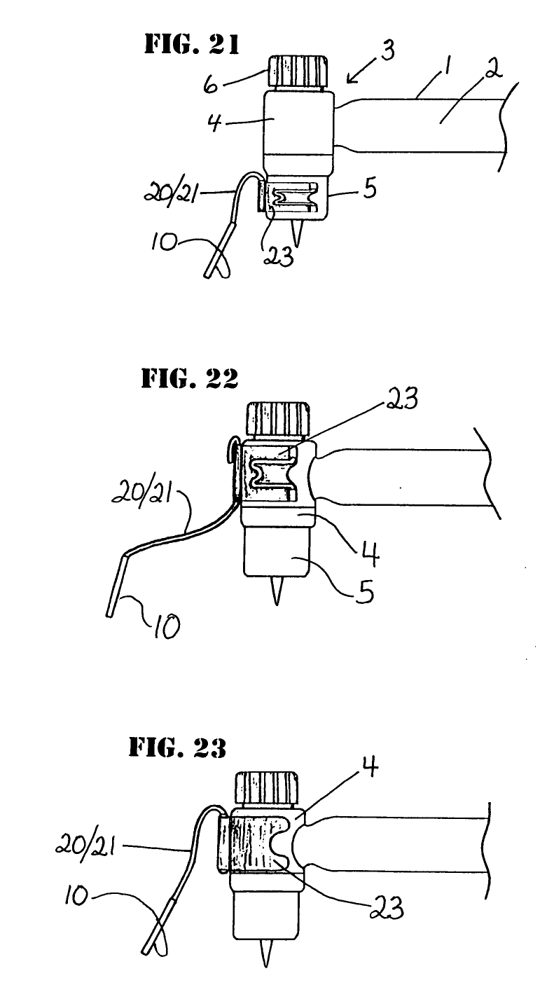

FIG. 21 is a side view of an embodiment of a mirror attached to an otherwise standard GTAW torch, in which the attaching member includes a wire and a terminal clamp that is similar to a clamp style paper clip with folding leverage arms. Attachment is to the gas nozzle of the torch.

FIG. 22 is a side view of another embodiment of a mirror attached to an otherwise standard GTAW torch in which the attaching member includes a wire and a clamp that is similar to a clamp style paper clip with folding leverage arms. The clamp of the present embodiment, however, is of a larger variety than that found in FIG. 21, and it is clamped onto the head of the torch as opposed to its gas nozzle, although it may be used with welding torches having larger sized gas nozzles.

FIG. 23 is a side view of an embodiment of a mirror attached to an otherwise standard GTAW torch, in which the attaching member includes a wire terminating with a metal spring clip. The spring clip is attached to the head of the torch. Compare, FIG. 20.

FIG. 24A, a rear view, and FIG. 24B, a top view, show a mirror that is annularly shaped like a flattened donut, which can surround a gas nozzle of a GTAW or PAW welding torch. The mirror in this embodiment can be attached to the gas nozzle with an attaching member that terminates with a spring clip. The embodiment is equipped with a swivel, which mounts and swivels on the back side of the mirror, to adjust the angle of the mirror in relation to the torch or weld region. The orientation of the mirror can be changed by rotating it around the axis of the gas nozzle. Although depicted and described as being annular and so forth, the mirror can have any suitable shape, be of any suitable size, or be made of any suitable material(s).

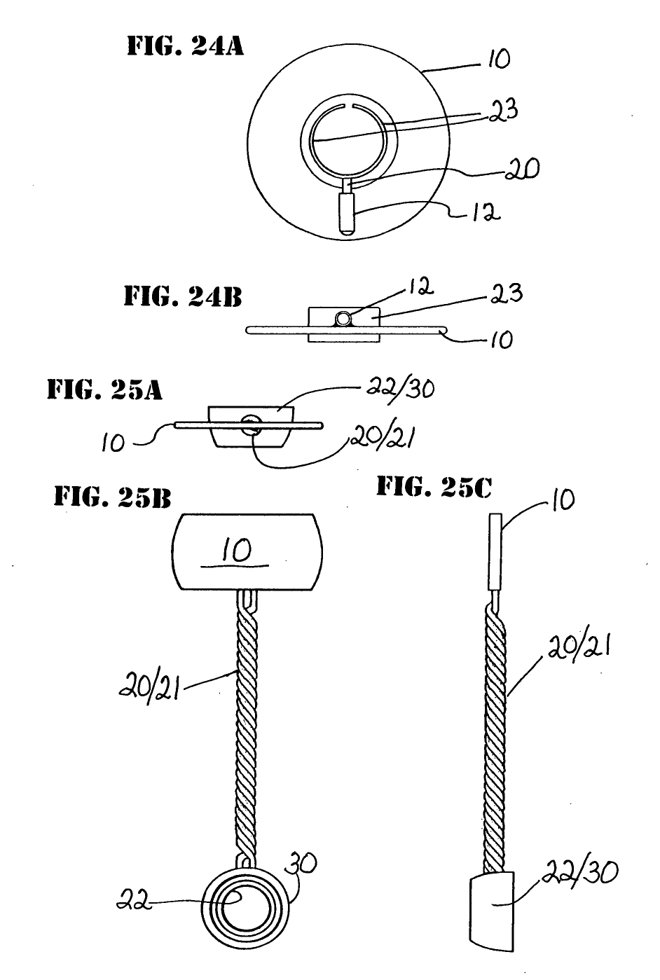

FIG. 25A, a top end view, FIG. 25B, a front view, and FIG. 25C, a side view, show an embodiment that has a mirror and, as its attaching member, a set of flexible wires, molded into the body of a terminal insulator. Two or more flexible wires are twisted together to keep the wires compact and contained. Extra insulation can encapsulate the twisted wires. Such a twisted wire attaching member may be formed to provide an internal hollow channel leading to the mirror so as to allow passage and protection of a transmission cable, fiberscope and/or shielding gas.

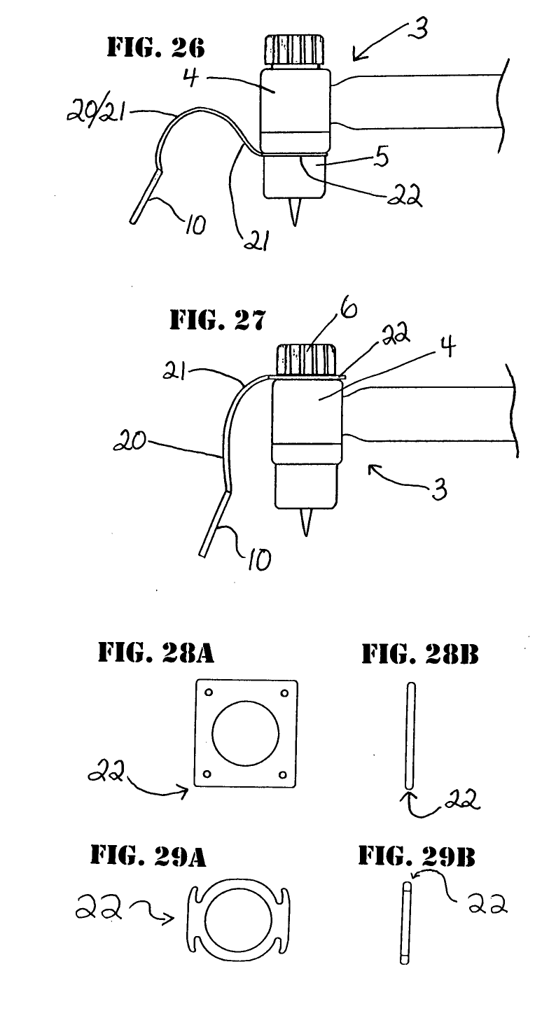

FIG. 26 is a side view of an embodiment of a mirror and attaching member attached to a GTAW torch wherein part of its attaching member is a terminal attachment washer. The attachment washer is fused to the attaching member arm, which arm can be flexible. The attachment washer is retained between the gas nozzle or the torch, which is screwed onto the head of the torch, and the insulator of the torch. The attachment washer can be rotated around the axis of the gas nozzle, by slightly loosening the gas nozzle.

FIG. 27 shows the same embodiment of the invention as in FIG. 26 except that in this case the attachment washer is placed between the cap and the head of the torch.

FIG. 28A, a top view, and FIG. 28B, a side view, show an embodiment of an attachment washer not permanently fused to an attaching member arm. This embodiment has holes through which an attaching member, say, made up with flexible wires, can be fed and used to secure it to the torch through the washer. This also provides for ready interchangeability and adjustment of the attaching member and mirror.

FIG. 29A, a top view, and FIG. 29B, a side view, show another embodiment of an attachment washer not permanently fused to an attaching member arm. Here, the attaching member, say again, flexible wires, is secured to the attachment washer by wrapping them around protrusions on the washer. Compare, FIGS. 28A and 28B.

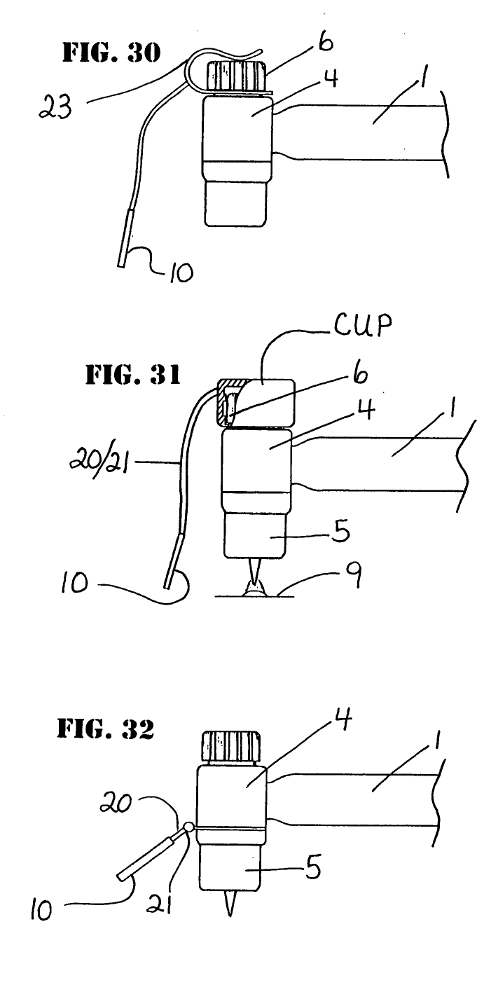

FIG. 30 is a side view of a mirror and attaching member attached to a GTAW torch wherein part of its attaching member is a terminal attachment claw. Here, the terminal attachment claw, rather than being, say, a flat ring washer, has a C-shape. This allows the terminal attachment claw with the attached attaching member arm and mirror to slide on and off the torch without having to remove the cap of the torch. The top, external portion of the attachment claw is a springy finger, which, in conjunction with the other finger, exerts sufficient pressure to securely clip and hold the attachment claw onto the cap.

FIG. 31 is a side view of a mirror and attaching member attached to a GTAW torch wherein part of its attaching member is formed as a cup shaped part, which can be pushed onto the cap of the torch. The cup can be made of a flexible material such as high temperature silicon. The cup may act as suction cup, further securing the attaching member and mirror in place.

FIG. 32 is a side view of a mirror and attaching member attached to a GTAW torch, with the attaching member having an arm that terminates in an attachment washer. In lieu of the washer, a horseshoe comparable to the terminus of various electrical wire terminal connections, or a clamp, clip or claw may also terminate the arm. The attaching member, however, which joins the mirror to the welding torch, includes a single ball and socket swivel joint.

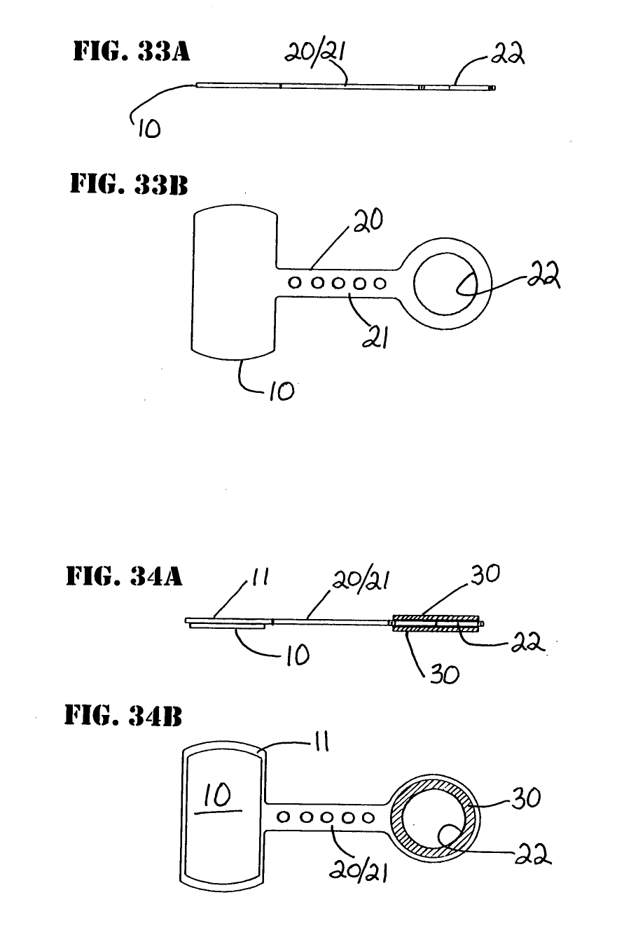

FIG. 33A, a side view, and FIG. 33B, a front view, show an embodiment of a mirror for a welding torch, which is constructed in a form of a single sheet of material, say, copper, stainless steel, or another suitable metal or alloy, or is constructed by fusing parts made up with different materials. The mirror is on one end, and a flat attaching member has a sturdy but flexible elongate arm that may have several holes to improve flexibility, lightness, and reduce heat transmission such as not only by making a path for heat conduction more convoluted but also by an increase in surface area and an increase in air flow about the arm for an increase in radiation and convection of heat from the arm and hence the mirror and so forth. Also, increased cooling may be provided intrinsically with such features as fins and so forth. The arm terminates effectively in a built-in attachment washer. The washer portion can be sandwiched between the gas nozzle and insulator of the torch, or between the cap and head of the torch. When made of separate parts fused into one, integral assembly, the arm and washer portions together can be made in one piece, say, of a flexible, sturdy band of copper or any suitable metal alloy. The mirror portion can be constructed of a polished metal, and fused to the other end of the flexible support member such as by welding.

FIG. 34A, a side view, and FIG. 34B, a front view, show an embodiment that provides further improvements to an embodiment such as of FIGS. 33A and 33B. The attaching member includes in its structure the attachment washer, the flexible arm, and a support for a mirror. The mirror is fixed directly to the surface of the mirror support. The attachment washer is insulated with two insulating washers or a grommet made of any insulating material such as high temperature silicon, which can reduce conduction of heat from/to the mirror with attaching member to/from the body of the welding torch.

FIG. 35A, a top view, FIG. 35B, a front view, and FIG. 35C, a side view, show an embodiment that provides for enhanced acceptance of an optical pick-up device, which greatly increases reach and flexibility of use. The optical image pick up device can be fixed to the back side of the mirror. The mirror, when used with an optical image pick-up device, can serve as a reflective protection barrier to protect the optical image pick-up device from the welding processes, electric arc rays, high heat, fumes and spatter, as well as enhance the lighting characteristics about the weld for optical pick-up. In addition, reflections in the mirror may be viewed directly by the welder without using the optical image pick-up device. A small hole can be provided in the face of the mirror through which the optical image pick-up device receives an image of the weld region. Transmission cable for the optical image pick-up device can be placed along the backside of the mirror and attaching member to guide, support, and protect it from the harsh environment of the welding operation. A small support for the transmission cable can be seen in FIG. 35C, which support can be made of an insulation material such as high temperature silicon or ceramic. The transmission cable can be fed from there to an image viewer. The image viewer receives and displays an image of the weld region for the user. The optical image pick-up device can be secured to the arm of the attaching member, which may be flexible. A layer of insulation may be provided between the optical image pick-up device and a supporting body. The mirror also may have a layer of insulation between itself and the supporting body. The insulation can be formed in strips, creating air space behind the mirror for increased cooling and minimum heat conduction to the optical image pick-up device.

FIG. 36A, a top view, FIG. 36B, a front view, and FIG. 36C, a side view, show an embodiment based on that of FIGS. 35A-35C, except for several variations. Attachment to a welding torch can be by a metal spring clip, fused about one end of a non-perpendicularly angled arm of the attaching member, which, again, can be flexible. A hole in the mirror provides access and protection for the transmission cable. This configuration allows the transmission cable to be brought along the side of the welding torch with the flexible arm serving as a protection barrier that can support, guide and protect the transmission cable from the heat, light and spatter about weld region. The front side of the flexible support member can be coated with an insulation material such as high temperature silicon to further protect the transmission cable from the welding environment. Using insulation such as high temperature silicon can add support and help to prevent kinks and sharp bends to the flexible arm of the attaching member.

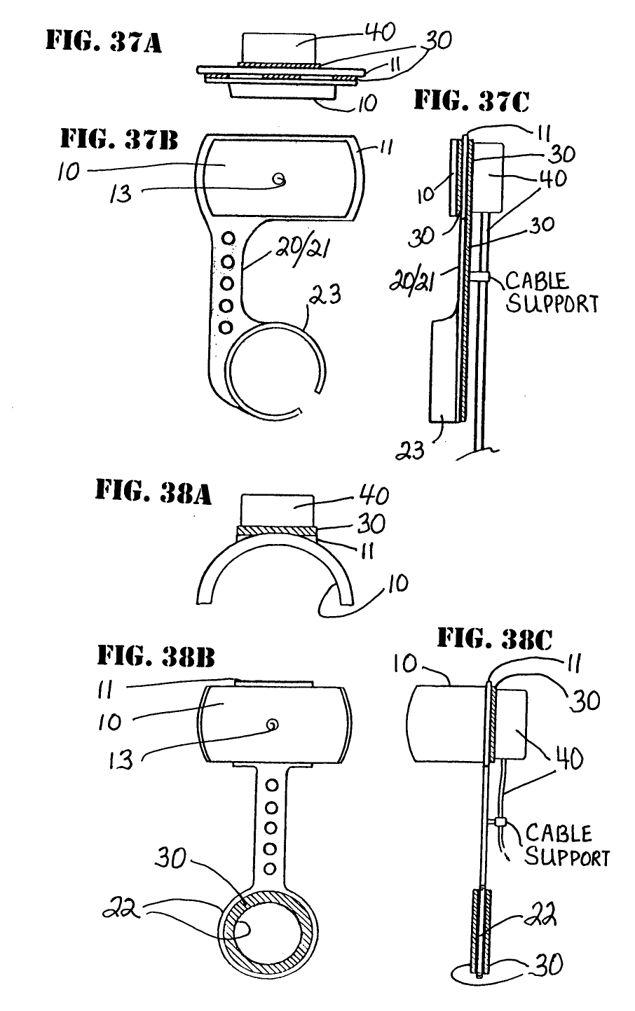

FIG. 37A, a top view, FIG. 37B, a front view, and FIG. 37C, a side view, show an embodiment based on that of FIGS. 35A-35C, except that the arm of the attaching member is offset from a central portion of the lower, outer boundary of the mirror and the spring clip in a straight manner, especially being perpendicular with respect to the lower mirror outer boundary, rather than on a non-perpendicular angle. The arm may be flexible. A hole in the mirror provides access and protection for the transmission cable.

FIG. 38A, a top view, FIG. 38B, a front view, and FIG. 38C, a side view, shows an embodiment based on that of FIGS. 35A-35C, except that the mirror is shaped as a parabolic dish to concentrate the reflection of the arc welding light back to the weld region for enhanced operation of the optical image pick-up device. The mirror otherwise can be made of any suitable shape or size for this purpose. A hole in the mirror provides access and protection for the transmission cable.

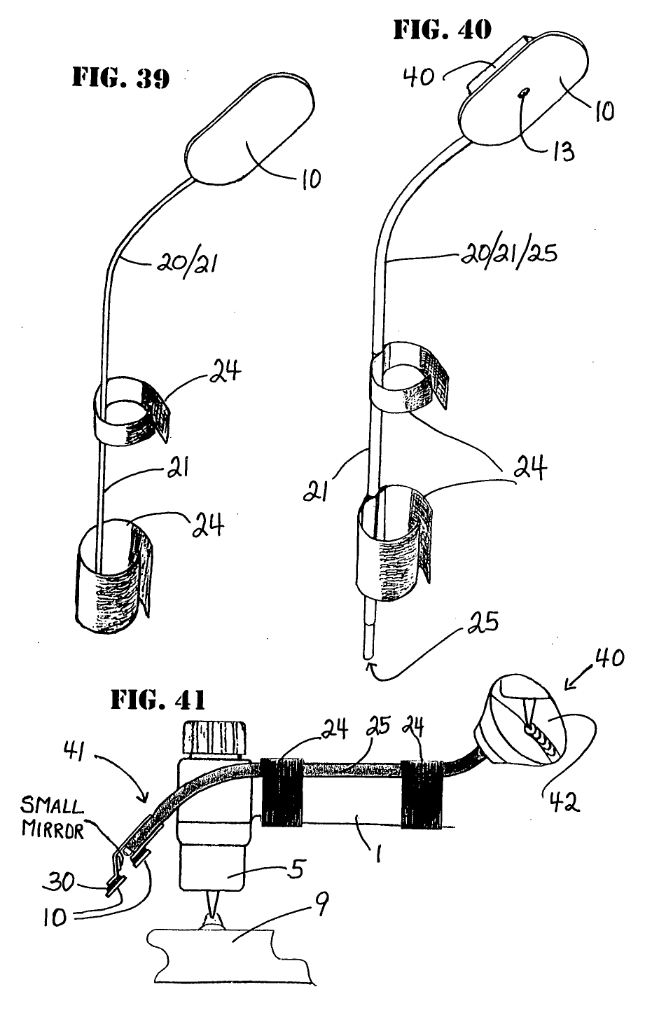

FIG. 39 is a perspective view of an embodiment that allows for the mirror and attaching member to be attached to the side of a welding torch. Attachment can be provided, for example, with straps having hook and loop fastening material. The attachment also can be provided by clamps, clips, tape, straps with buckles, tie strings or wires, and so forth and the like. The attaching member here is a flexible metal wire. The mirror can be fused to the end of the wire. This embodiment can be constructed so as to provide for interchangeability of mirrors with their attaching members.

FIG. 40 is a perspective view of an embodiment based on features found in the embodiment of FIG. 39, except that this embodiment is equipped with an optical image pick-up device. The attaching member can be a hollow flexible tube. A transmission cable of the optical image pick-up device can be conveyed to the viewing head portion of the invention within the flexible support tube. A hole in the mirror provides access and protection for the transmission cable.

FIG. 41 is a perspective view of an embodiment that is based on that of FIG. 40, in partial cross-section, with a fiberscope as the optical image pick-up device. This embodiment has five main components: 1) a viewing head; 2) an attaching member of a flexible tube; 3) the fiberscope cable; 4) fastening straps; and 5) an image viewer. The viewing head is basically based on the mirror with a centrally located hole through it, with an optical image pick-up device hiding behind it for protection. The image of the weld region travels through a small hole in the center of the main mirror, in the ambient air or an inert gas atmosphere, to a small mirror inside a distal end of the guide tube. The image is reflected ninety degrees by the small mirror, to a fiberscope lens. The lens receives the image; in turn, the image is transmitted through the fiberscope cable to the image viewer. The image viewer receives and displays the image of the weld region for the welder to observe. Light filtering lenses can reduce the brightness of the electric arc and block out dangerous UV light. Such filtering lenses can be incorporated into the image viewer, the viewing head, and so forth; or the welder can observe the image on the image viewer display by looking through his welding shield that is already equipped with a light filtering lens. Auto darkening light filter lenses can also be employed. A guide tube, say, made of metal, can be fixed to the backside of the mirror with an insulation layer provided in-between. The guide tube securely receives the attaching member of flexible tube, and can be attached to the welding torch by employment of the fastening straps. The fiberscope cable is carried through and protected by the attaching member of flexible tube. The flexible tube gives structure and allows the viewing head to be positioned in any suitable position and remain there. The image viewer on the opposite end of the flexible tube is also adjustable so as to be positioned in any way desired. The image viewer can be placed on the welding torch handle for easy viewing by the welder, in any suitable position, for example, by employing longer lengths of fiberscope cable. Auxiliary lighting of the weld region can be provided, for example, before and after welding, say, through illumination through fiber optics.

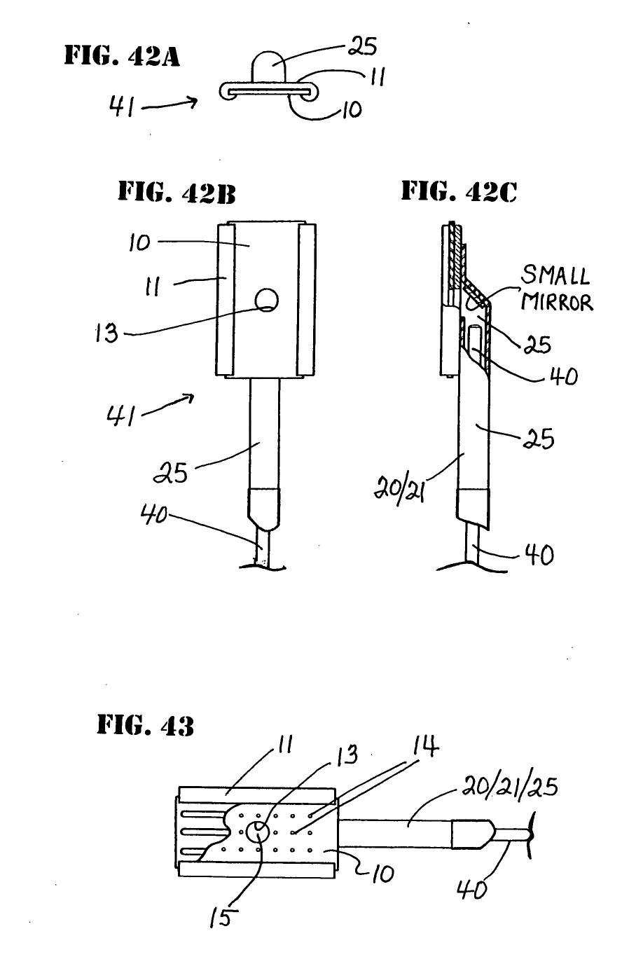

FIG. 42A, a top view, FIG. 42B, a side view, and FIG. 42C, a front view in partial cross section, of a viewing head, based on the viewing head within FIG. 41, which further is equipped with a shielding gas system for superior cooling and for added protection from the harsh environment. The shielding gas can be provided from the same source of shielding gas that is used to shield the molten weld puddle from the atmosphere during the welding process. The shielding gas can be conveyed to the viewing head through the attaching member, for example, a flexible support tube. With shielding gas flowing into the viewing head, the fiberscope lens, the small reflecting mirror, and the image receiving hole are kept free of smoke, fumes, sparks, and debris. The shielding gas greatly reduces heat gain to the fiberscope cable, the flexible support tube, the fiberscope lens, the small mirror, the guide tube, the mirror support, and the larger main mirror. The flexible support tube is provided with sufficient internal space to provide passage of the shielding gas around the fiberscope cable. The shielding gas can exit the viewing head from a central portion of the main mirror, for example, through the image viewing hole. This produces a clean and clear column of shielding gas along the field of view from the image receiving hole. The guide tube receives the flexible support tube, the fiberscope transmission cable, and the shielding gas. The flexible support tube can be securely sealed to the guide tube. The mirror support can be fixed to the guide tube. Although the guide tube and the mirror support may be made as a one part, say, molded of a material such as porcelain or ceramic, the guide tube also can be a cylindrical metal tube joined to the mirror support that can be made of either porcelain, ceramic or glass. The bottom of the guide tube is open to allow the image of the weld region to pass and enter the image viewing head. Use of the shielding gas is an excellent way to keep the pertinent components cool. The shielding gas exiting the viewing head will also add to the volume of shielding gas at the weld region. In some situations though, a flow of shielding gas coming from one small hole in the mirror may cause undesired turbulence in the weld region, which, at times, may bring air into the weld puddle area and result in a compromised weld. In such a case, the flow of shielding gas may be made to be less turbulent about the weld, for example, by lowering the flow speed of gas exiting the single hole in the mirror, say, by lowering the flow of shielding gas through the flexible support tube, by increasing the size of the single hole, or by providing a plural number of exit holes for the shielding gas, which are suitably directed with respect to a weld region.

FIG. 43 is a front view of a viewing head such as shown in FIGS. 42A-42C, except that the viewing head is equipped to distribute the flow of shielding gas more evenly over a large surface area, thus reducing the chance of disturbing the shielding gas during welding. Here, the optical image receiving hole is in the center of the mirror face, and smaller holes are located on the mirror face along shielding gas supply channels. The channels are formed into the mirror support beneath the position of the mirror. The channels distribute the shielding gas to all the small holes on the mirror face. The small holes collectively increase the discharge area of the shielding gas, effectively reducing the velocity of the shielding gas flow from the mirror face. The slower, smoother flow of cooling/shielding gas from the face of the mirror creates minimal turbulence, which leaves the shielding gas at the weld region undisturbed. This also gives the mirror a fuller cooling effect and even more effectively shields the entire mirror face from the weld region. The small holes in the main mirror serve their purpose without causing a significant reduction in the reflective properties of the mirror, either when used as a reflector for an optical image pick-up device or when being used by the welder for direct viewing of the reflected image of the weld region from the mirror face. Instead of channels, the mirror support can be formed with a recess behind where the mirror sits so as to create a plenum space for the shielding gas to collect and be distributed from. In addition, at times it may be desired to fit the image viewing hole with a lens, which can directly shield the inside of the viewing head to provide for initial light-filtering or to magnify the image of the weld region. The lens can be made of any suitable material such as quartz or glass. When fitted with such a lens, which extends to and seals with the boundary of the central hole in the face of the mirror, the shielding gas does not flow through the image viewing hole but instead exits through the rows of smaller holes in the mirror. Furthermore, the mirror face is not the only part that can be modified to dispose the shielding gas. For example, shielding gas channels may be formed in a mirror support to extend to its outer edges to provide for an exhaust of the shielding gas outwardly from the perimeter of the mirror support, which arrangement may be employed in a case where the mirror has holes for exit of a shielding gas or in a case where the mirror has no holes for exit of a shielding gas, say, where a lens is present, or even where a lens for an optical image pickup device is absent.

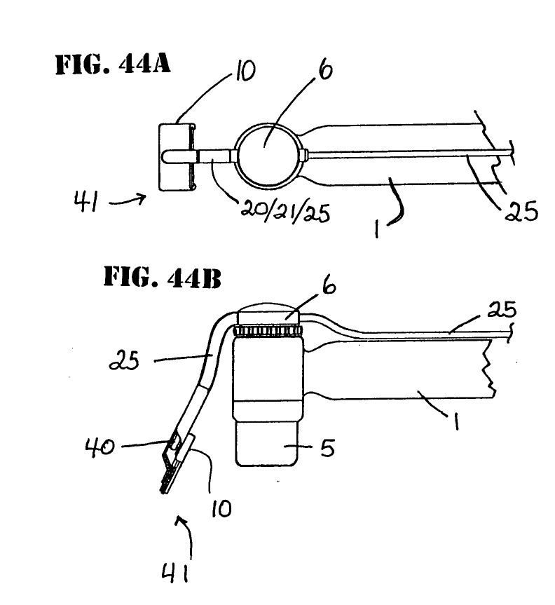

FIG. 44A, a top view, and FIG. 44B, a side view, show a mirror with attaching member and shielding gas distribution incorporated into the cap of a GTAW torch. This provides both for securing the mirror and attaching member to the torch and a source of shielding gas for cooling purposes. Generally, known welding torch caps function as a screwed on clamping device, which exerts pressure on an electrode holder collet within the welding torch head; the electrode holder collet holds the tungsten electrode securely when the welding torch cap is tightened; and the welding torch cap also contains the shielding gas within the welding torch. Hereby, a welding torch cap may be adapted to provide for diversion of a source of shielding gas, with excellent outcome. For example, as depicted here, the welding torch cap can receive a fiberscope cable from the backside of the cap, where it is passed through to an attaching member, say, a flexible support tube, for conveyance to the viewing head with its mirror. The flexible support tube can be fixed to the front side of the welding torch cap. The shielding gas from the welding torch can pass through the flexible support tube along with a fiberscope cable. The welding torch cap can be screwed on to the welding torch head, which can have a lower spindle. The spindle allows the torch cap to be tightened to the torch without disturbing the fiberscope cable and the flexible support tube.

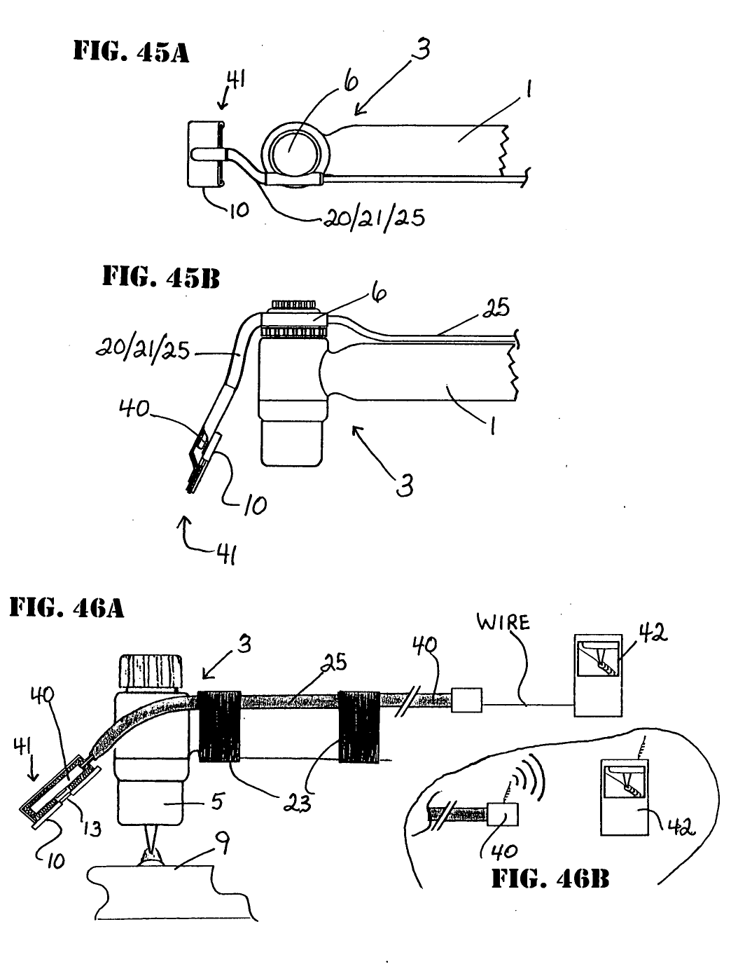

FIG. 45A, a top view, and FIG. 45B, a side view, show an embodiment such as shown in FIGS. 44A and 44B, which, however, further has a control valve for adjustment of the shielding gas flow. The flexible support tube and transmission cable set off to one side of the welding torch cap to allow space for the control valve. A screw for the control valve can enter through the top of and be centered with respect to the central axis of the torch cap. The control valve screw can seat against a valve seat below the entry point of the fiberscope cable. When the screw valve is opened, shielding gas flows from the welding torch head into the inside hollow of the welding torch cap, then into the flexible support tube, and then to the viewing head and exhausted, for example, out hole(s) in the mirror and/or its support on its periphery. Generally, typical welding torches are equipped with a shielding gas control valve on the body of the welding torch, and that valve can be employed to control the flow of shielding gas going to the head of the torch. Hereby, in light of the provisions for shielding gas to the viewing head as shown in FIGS. 44A-45B, a shielding gas control valve on the body of a welding torch can be modified to provide shielding gas to the viewing head with its mirror, or to a more simple mirror without an optical image pick-up device. Another source of shielding gas can be the shielding gas supply hose to the welding torch itself, where, for example, a splitter fitting can be set up anywhere along the shielding gas supply hose to have gas drawn from the supply hose and supply shielding gas to the viewing head with its mirror or to a more simple mirror without an optical image pick-up device.

FIGS. 46A and 46B are side plan views in partial cross section, which show an embodiment based on that of FIG. 41, except that, instead of a fiberscope, the optical image pick-up device is a CCD camera. This embodiment is attached to the welding torch with one spring clip or more, say, a pair of, spring clips. The spring clip(s) can be fixed to the flexible support tube. Transmission of the image from the viewing head may be carried out with a direct (hard wired) electrical or electronic connection (FIG. 46A) and/or wirelessly, for example, by electromagnetic radiation, say, radio waves, and so forth (FIG. 46B) for allowing the welder to place a small video display in any suitable location without wires or cables, which is a great advantage to him. The CCD camera can be surrounded with insulation and placed within a protective container. An attaching member, again, can be a flexible support tube, which can flexibly support the mirror, and house the transmission cable in communication with the viewing head. The video display can be secured in any suitable position, for example, with magnets, straps, hooks, and so forth. The video display may even be mounted to the inside of the welder's welding helmet for heads-up display viewing. Moreover, the electronic camera may be combined with a fiberscope or vice versa. In such an arrangement, the fiberscope receives, transmits and displays the image of the weld region to a camera that is placed safely away from the harsh conditions of the welding process, with the camera converting the light image into electronic data. Once converted to an electronic format, the image can be recorded and manipulated in various ways and can also be transmitted wirelessly.

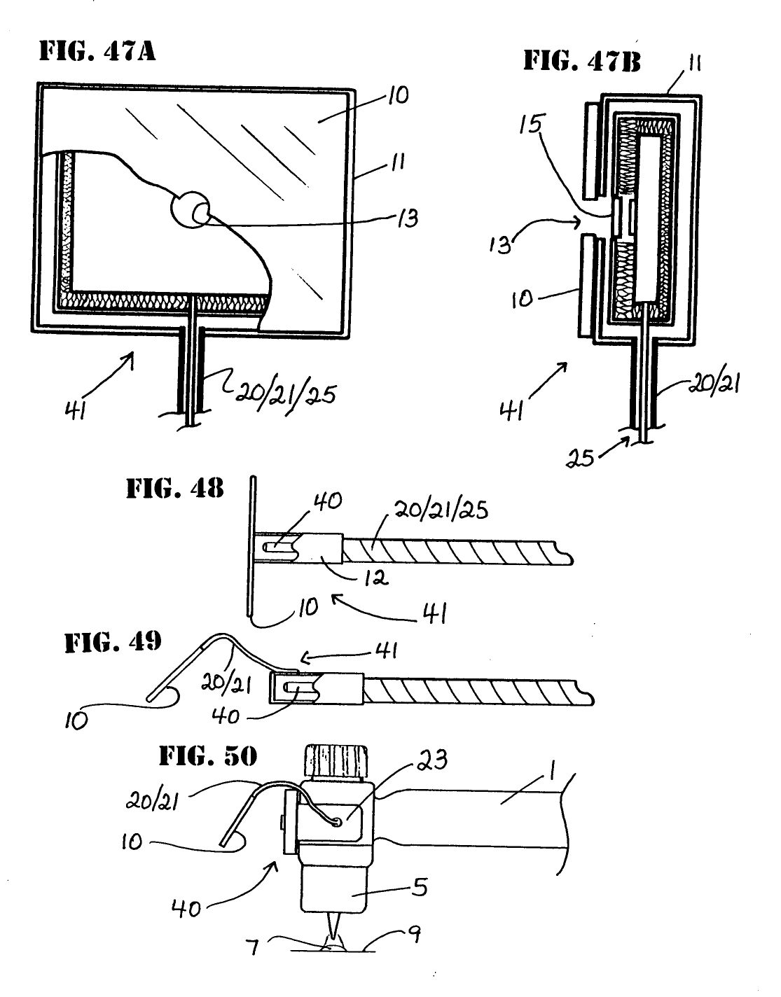

FIG. 47A is a front view in partial cross-section showing a viewing head, and FIG. 47B is a cross-sectional side view of the viewing head shown in FIG. 47A at a plane along its vertical midpoint. This viewing head is generally a head such as based upon the head shown within FIG. 46, except here the protective container is housed within a cooling shroud. The cooling shroud contains the protective container, within which is the insulated CCD camera. The mirror is fixed to the front of the shroud. An image viewing hole is in the center of the mirror, with a corresponding hole in the shroud. An attaching member, again, a flexible support tube, is strongly and securely sealed to the shroud. The lens of the protective container provides a sealed, see-through barrier for the CCD camera. The transmission cable is fed from the CCD camera through a hole in the side the protective container, and then through a corresponding hole in the side of the shroud to the inside of flexible support tube. The transmission cable travels through the flexible support tube to the image viewer. Shielding gas enters from the flexible support tube and flows around the inside of the viewing head, keeping the CCD camera safe and cool. The shielding gas exits at the image viewing hole.

FIG. 48 is a side plan view in partial section, which shows a configuration of a viewing head that receives the end of a fiberscope cable. The mirror can be fixed to the end of a guide tube at right angles to the axis of the guide tube. The guide tube can be attached to a long length of flexible support tube, which may serve as an attaching member. The flexible support tube can be wrapped around, strapped, tied or otherwise attached to a welding torch. The embodiment shown can also be wrapped around any item or object other than the welding torch from where an image receiving lens can view the weld region. The flexible support tube allows the viewing head and the entire length of the attaching member to be positioned in any suitable way and remain in that position. The fiberscope cable is fed into the flexible support tube to the viewing head. The flexible support tube also protects the fiberscope cable and fiberscope lens from the harsh conditions at the weld region. A clear viewing lens at the end of the guide tube can protect the fiberscope lens from the harsh environment about the weld region. Shielding gas can be incorporated for cooling. The mirror may be of any suitable size or shape. This configuration can also be used with a CCD camera where the flexible support tube can be fastened to a protective housing containing the camera, and the transmission cable conveyed through the flexible support tube.

FIG. 49 is a side plan view in partial section, which shows an embodiment of a viewing head with attaching member along the line of FIG. 48, except that the mirror is attached to the guide tube with a flexible support wire as an attaching member. The fiberscope lens receives the image of the weld region by viewing a reflection of the weld region in the mirror. The mirror is adjustable to suit the situation. The forward facing end of the guide tube and the fiberscope lens can be protected from the weld region with a clear viewing lens. Shielding gas can also be incorporated for protection and cooling.

FIG. 50 is a side view of an embodiment that includes a CCD camera in a protective housing attached to a welding torch with a clip. A mirror is attached to the side of the protective housing with a flexible support member as an attaching member. The image of the weld region can be varied by adjusting the mirror relative to the camera.

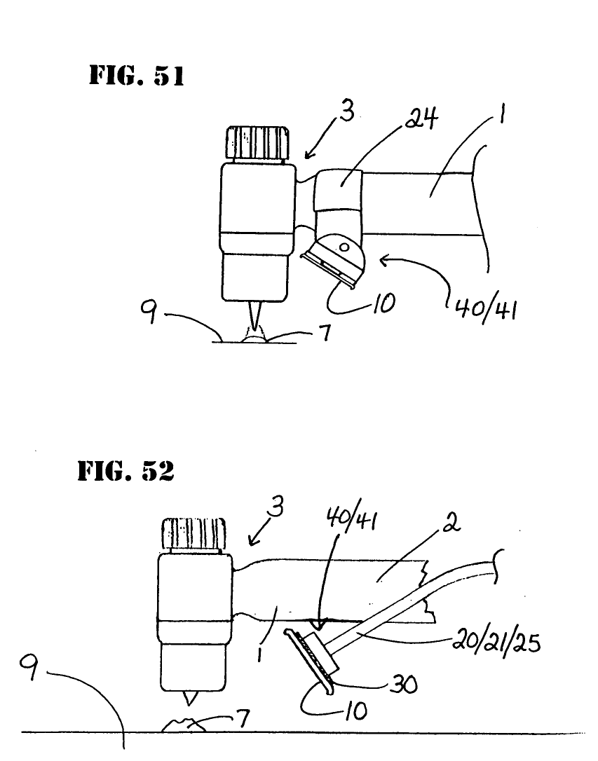

FIG. 51 is a side view of another embodiment including a CCD camera. This embodiment has a mirror attached to the face of the protective container, and the protective container is fitted with a pivotal adjustment hinge. The other segment of the hinge is attached to the welding torch with a Velcro strap. Compare, FIG. 50.

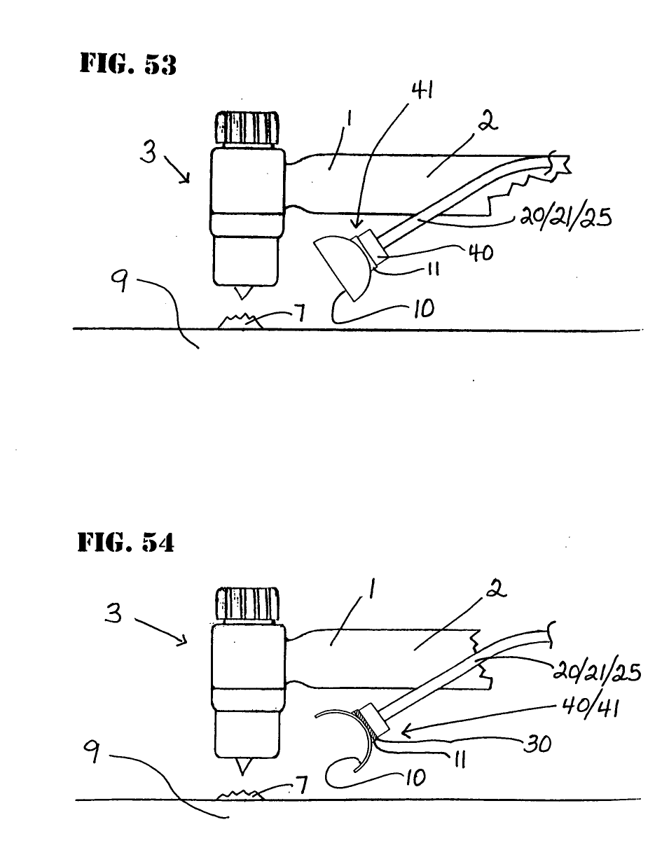

FIGS. 52, 53 and 54 are side views of other embodiments, which show the embodiments as described with reference to previous drawings. The purpose of these drawings is to illustrate different mirrors, which may be interchanged. All the drawings generally depict an optical image pick-up device that can be of any suitable kind. The mirrors of each drawing, however, are shaped differently. Thus, FIG. 52 illustrates employment of a flat mirror with beveled outer edges for an increase in light reflection; FIG. 53 illustrates employment of a dome shaped mirror for concentrated focus of the arc light; and FIG. 54 illustrates a simple trough like mirror.

FIG. 55 depicts a mirror system for attaching to a welding torch that includes a counterweight. The counterweight can assist in providing stability during welding.

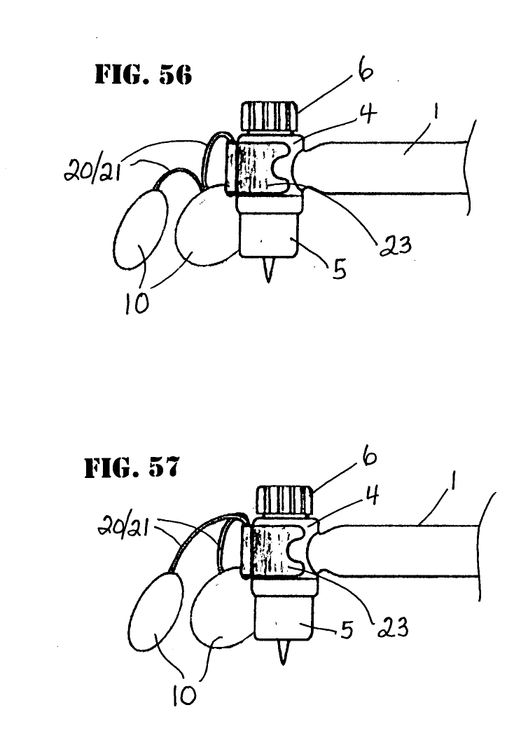

FIGS. 56 and 57 depict multiple mirror, mirror systems attachable to a welding torch. The mirrors may be, as it were, provided in a “series” arrangement (FIG. 56) as well as in a “parallel” arrangement (FIG. 57) by analogy to electrical wiring systems.

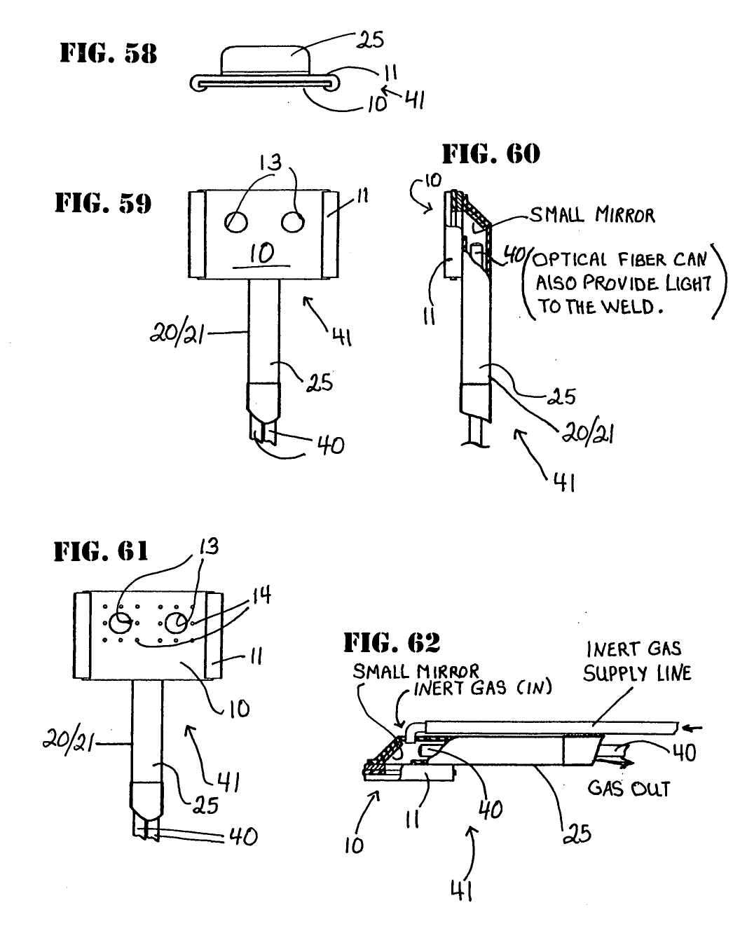

FIG. 58-62 illustrate mirror system embodiments having at least two holes in the same mirror, each of which have an optical image pick up device in, near or associated with it. Such an arrangement can provide for stereoscopic viewing. A top view is provided in FIG. 58; front views of embodiments otherwise able to be found in FIG. 58 are provided in FIGS. 59 and 61; and side plan views, with portions in section, are provided in FIGS. 60 and 62, with the lattermost also including inert gas return for cooling the optical image pick up device and then recycle. In FIGS. 59-61, inert shielding gas is provided through the mirror, to use near the mirror, say, to provide a more clear viewing path or stream to a weld area and to provide for the viewing head with its mirror system cooling and other protection such as from fumes from the weld.

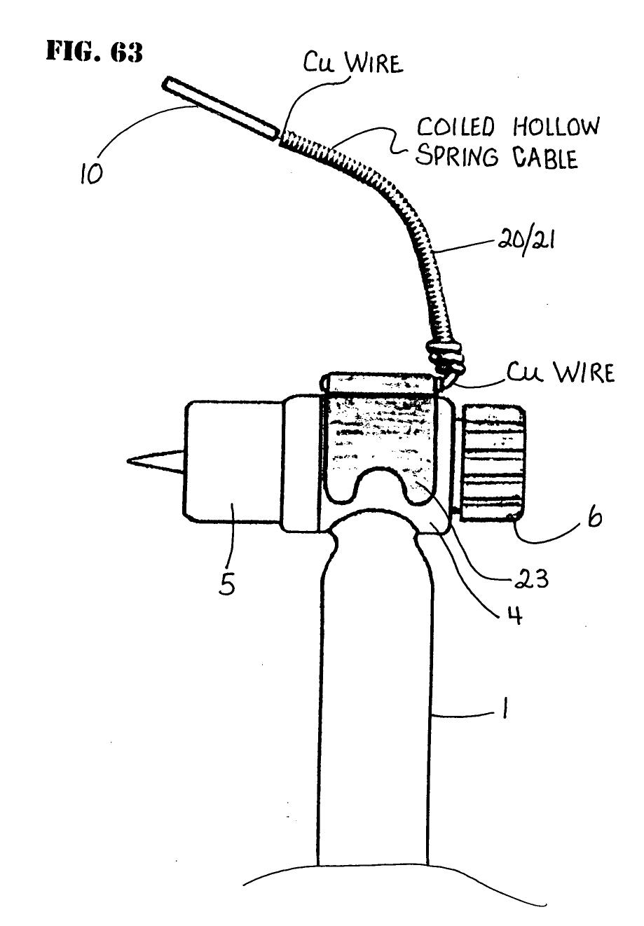

FIG. 63 depicts another embodiment hereof. It includes a flexible arm to its attaching member made with a flexible inner wire, for example, copper, surrounded by a coiled hollow spring cable, which prevents kinking of the flexible inner wire and provides a certain amount or rigidity to the arm of the attaching member. A clip serves to fasten the mirror system to the welding torch.

With further reference to FIG. 1 et seq. and the foregoing descriptions, features, parts, subcombinations and/or parts may be associated generally with numerals for ease of reference in the drawings, as follows:

| | |
|---|---|
| Torch | 1 |
| Torch handle | 2 |
| Torch head | 3 |
| Insulator | 4 |
| Gas nozzle | 5 |
| Torch cap | 6 |
| Weld | 7 |
| Weld region | 8 |
| Workpiece | 9 |
| Mirror | 10 |
| Mirror support | 11 |
| Attaching member | 12 |
| receiver | |
| Main viewing hole | 13 |
| Gas hole | 14 |
| Lens/lens cover | 15 |
| Attaching member | 20 |
| Arm | 21 |
| Arm terminal washer | 22 |
| Clip/clamp fastener | 23 |
| Strap fastener | 24 |
| Hollow passageway | 25 |
| Insulation | 30 |
| Optical image | 40 |
| pickup device | |
| Viewing head | 41 |
| Viewing screen | 42. |

The following examples further illustrate the invention:

### EXAMPLE 1

A section of a two-inch heavy wall steam tube in a boiler of a power generating station was in need of replacement. Only very limited viewing access was available to make the weld. Two skilled boilermakers working in unison, using known, standard mirror welding techniques, TIG welded the joints of the replaced section. One of the weld joints failed X-ray inspection. The weld defect was on the obscured side of the tube. Management was concerned that that weld joint section would need to be cut out and replaced, which would necessitate a time-consuming welding repair requiring additional obscured welds and further testing of the welds.

The inventor indicated that he might be able to make the necessary repair to the defective weld joint, and, upon his insistence, was left alone to do this. When this occurred, the inventor proceeded to attach a mirror system such as of FIG. 26 to his TIG torch, and then he made the weld repair with the TIG torch in combination with the mirror system. The welded tube fully passed X-ray inspection.

The management was very pleased with the results.

### EXAMPLE 2

A set of steel tubes in a boiler was in need of TIG welding. The tubes were vertically oriented in close proximity to each other to form a structure generally referred to as wall tubes. The wall tubes had limited access such that only several inches were available inside between the wall tubes and an obstruction. A usual method of having two welders, one on each side of the tubes in need of welding, was not possible to carry out. Welding, which needed to pass X-ray inspection, was needed all around the tubes.

Management recommended that the front of each tube be cut out to perform what is known as a window weld. A weld would be made to the inside of each tube, and then the cut out portion would be welded back in place.

The present inventor, said that that proposal was not necessary or desirable, and that he would make the necessary welds without cutting out the fronts of the tubes. The management was skeptical.

The inventor insisted that the management leave the area to leave only him and his welding companion there. When this occurred, the inventor proceeded to attach a mirror system such as of FIG. 63 to his TIG torch, and then to make the weld with the torch in combination with the mirror system, approaching from the rear, outside of each tube. The weld was accomplished from the rear, and the welded tubes fully passed X-ray inspection.

The management, without knowing how the inventor made the weld, lauded it.

The inventor's welding companion was also impressed. Privately, on the spot, he made an unsolicited offer to buy that or a like mirror system set up from the inventor.

### CONCLUSION TO THE INVENTION

The present invention is thus provided. Various feature(s), part(s), step(s), subcombination(s) and/or combination(s) may be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

What is claimed is:

1. A mirror system attachable to a welding torch, which comprises the mirror system, which includes a mirror and an attaching member that is useful for attaching the mirror system to the torch, wherein the mirror system is a part separable from the torch.

2. The mirror system of claim 1, wherein the mirror system has or has associated with it at least one of the following:
at least one hole through the mirror, which is useful for employment of at least one of an optical image pickup device and inert gas delivery; and
an inert gas delivery system that can deliver inert gas near, to and/or through at least the mirror of the mirror system.

3. In combination, a welding torch; and a mirror system attached to the torch.

4. The combination of claim 1, wherein the torch and mirror system are reversibly attachable to each another.

5. The combination of claim 3, wherein the torch is selected from the group consisting of GTAW and PAW torches.

6. The combination of claim 5, wherein the mirror system includes an attaching member that is adjustable.

7. The combination of claim 6, wherein the attaching member is selected from the group consisting of at least one flexible wire, at least one ball and socket joint, at least one swivel joint other than a ball and socket joint, and a combination thereof.

8. The combination of claim 5, wherein the mirror system has a counterweight.

9. The combination of claim 5, wherein the mirror system has a plurality of mirrors.

10. The combination of claim 5, wherein the mirror system has at least one front surface mirror with at least one hole passing therethrough.

11. The combination of claim 10, which further comprises at least one optical image pick up device that can obtain an optical image through at least one of the at least one hole.

12. The combination of claim 11, wherein at least one of the at least one hole through which the at least one optical image pick up device can obtain the optical image is closed with a light-transmissive cover.

13. The combination of claim 11, wherein the at least one optical image pick up device is set back from the at least one hole and obtains its optical image by reflection off a second mirror behind the at least one front surface mirror.

14. The combination of claim 11, wherein there are at least two holes passing through the at least one front surface mirror, and there are at least two optical image pick up devices, each of which can obtain an optical image through a separate hole passing through the at least one front surface mirror for stereoscopic viewing.

15. The combination of claim 11, wherein insulation is provided to protect the optical image pick up device and/or mirror; provide structure; provide heat isolation; and/or provide electric isolation.

16. The combination of claim 10, which further comprises a light source that can provide light to a weld area through at least one of the at least one hole.

17. The combination of claim 10, which further comprises an inert gas delivery system, which can deliver inert gas through at least one hole of the at least one hole of the at least one front surface mirror.

18. The combination of claim 11, which further comprises an inert gas delivery system, which can deliver inert gas through at least one hole of the at least one hole of the at least one front surface mirror.

19. The combination of claim 3, wherein the mirror system includes at least one front surface mirror.

20. An article of manufacture comprising a mirror having a reflective surface, which has at least one hole through the reflective surface; an optical image pick up device, which can obtain an optical image through at least one of the at least one hole; and an inert gas delivery system, which can deliver inert gas through at least one hole of the at least one hole.
